(19) United States
(12) Patent Application Publication
(10) Pub. No.: US 2014/0245813 A1
(43) Pub. Date: Sep. 4, 2014

(54) Fluid System Health Monitor

(71) Applicants: Nathan T. Baltz, Niwot, CO (US); Bradford Limoges, Golden, CO (US); Alan E. Baron, Boulder, CO (US)

(72) Inventors: Nathan T. Baltz, Niwot, CO (US); Bradford Limoges, Golden, CO (US); Alan E. Baron, Boulder, CO (US)

(21) Appl. No.: 14/148,447

(22) Filed: Jan. 6, 2014

Related U.S. Application Data
(63) Continuation of application No. 13/885,775.
(60) Provisional application No. 61/414,159, filed on Nov. 16, 2010.

(51) Int. Cl. G01N 21/64

(52) U.S. Cl. CPC G01N 21/64
USPC 73/19.01

(57) ABSTRACT

A fluidic system comprising a force-transfer fluidic system with at least one fluidic component comprising a TDG sensor comprising in some embodiments an oxygen sensor, a luminescent oxygen sensor, or an electrochemical oxygen sensor. The system may further comprise a pressure transducer, a chamber and a membrane forming at least a portion of the chamber wall, the membrane being in direct or indirect contact with fluid or gas above the fluid. The TDG sensor may comprise control logic and an output of the control logic may be used directly or indirectly to control at least one process parameter of the system, including pressure and flow rate, and the control logic also may be used to notify the need for purification or to alert that a certain purity has been achieved.

### RELATED APPLICATIONS

This application is a continuation of U.S. application Ser. No. 13/885,775 filed May 16, 2013, which is a 371 entry of International Application No. PCT/US2011/061087 filed Nov. 16, 2011, which claims the benefit of the filing date of U.S. Provisional Application No. 61/414,159, filed Nov. 16, 2010. All of the aforementioned applications are incorporated herein by reference in their entireties.

### GOVERNMENT INTEREST

The disclosed subject matter was made with Government Support under a Phase I and Phase II SBIR Contract with the Department of Defense, Air Force contract FA8650-06-M-5031 and FA8650-07-C-5005, respectively. The US government has certain rights in this invention.

### FIELD

The disclosed subject matter is in the field of fluidic system health monitoring. In particular, the disclosed subject matter is directed to systems and methods for measuring total dissolved gases in fluid streams contained within fluidic systems, for the purpose of monitoring fluidic system health and purity of fluid streams.

### BACKGROUND

Fluidic systems consist of conduits that contain liquids for diverse purposes including the transmission of fluidic volume or mass or fluidic pressure. A hydraulic actuation system is an example of a fluidic system that efficiently transfers force from one location to another. A hydraulic system may actuate control surfaces in an aircraft or ship, or may actuate a digging implement or lift bed in a piece of machinery, or may provide the propulsive force for a rotating motor actuator. Fluidic systems also include manifolds or radiators which circulate various liquids for cooling different type of industrial machinery.

An undersea or over-land crude oil pipeline is an example of a fluidic system that transfers volume of a material from one location to another. Volume-transfer fluidic systems are used in petroleum refining, chemical manufacture, water transfer, and food beverage and industrial applications

Common features to fluidic systems include pipes, valves, pistons, actuators, servos, turbines, pumps, flow capacitors, reservoirs, unions and the like. Proper function and integrity of such fluidic components are crucial to the safe and efficient operation of a force- or volume-transfer fluidic system. The phenomenon of cavitation in fluidic systems can accelerate wear and failure of such components. Cavitation is the process where free bubbles of fluid or contaminants rapidly evolve and redissolve in the fluid when subjected to sufficiently large and varying negative pressures. Cavitation causes rapid erosion and wear of fluidic components, rises in temperature and stress that contribute to early or unexpected failure of fluidic components. It is therefore desirable to operate the fluidic systems under conditions of fluid purity, flow rate and pressure that prevent cavitation.

Contamination of hydraulic fluid, for example, affects the health of a force-transfer fluidic system. Generally hydraulic fluid is assumed to be an incompressible medium capable of transmitting force through large positive or negative pressures. Air and water may enter hydraulic fluid either through normal use, as a result of servicing the fluidic system, or by recharging a system with hydraulic fluid contaminated with air and water. The air and water dissolved in hydraulic fluid increase the susceptibility to cavitation and also result in slow, erratic, unpredictable or spongy behavior during actuation. In an aircraft this behavior leads to loss of performance, decreased safety, and increased maintenance costs as fluidic components must be replaced more often than desired.

Similarly, water and air dissolved in the fluid of a volume-transfer fluidic system will reduce the maximum practical flow rates and pressures, and will reduce fluidic component service life. In order to avoid fluidic component failure due to cavitation caused by evolution of contaminant gases, the flow rate and pressures of a volume-transfer fluidic system must be set conservatively low. This results in a lower system efficiency which does not maximize the economic potential of a volume-transfer process.

A known and contemporary apparatus for measuring dissolved gas contaminants in hydraulic and other fluids uses a gas chromatograph to determine dissolved gas concentration in volume percent units. A small sample, for example 100 ul, is taken from a fluidic system in a gas impermeable syringe. The 100 ul sample from the syringe is introduced into a gas chromatograph provisioned with a pre-treatment column that traps the fluid and allows the dissolved gases to evolve. The evolved gases travel through the chromatograph and are detected with a thermal conductivity or other detector system. The area of the peak from the injected fluid is compared to the peak are produced by a standard, typically a 100 ul, volume of air injected in a similar manner. Such a method has been described in the open literature and in the US publication Military Aerospace Fluids and Lubricant Workshop Proceedings, November 2004.

The contemporary apparatus using gas chromatography exhibits serious drawbacks; its accuracy is limited, it does not provide real time measurements, it is difficult and expensive to implement on-line or in-line, and requires a human operator. The contemporary apparatus cannot be incorporated into a fluidic component, therefore cannot provide real-time TDG concentration for optimization of flow and pressure in force- or volume transfer fluidic systems.

### SUMMARY

The apparatus (systems and/or devices) and methods of the disclosed subject matter improve on the contemporary apparatus, as the disclosed subject matter allows for; detection of total dissolved air in fluids contained in fluidic systems, indication of need for purification, and purity measurement for optimization of fluidic system operational parameters. Additionally the disclosed subject matter provides real-time, unattended, on line or in-line measurements of total dissolved gas using inexpensive and robust devices.

One embodiment of the disclosed subject matter provides for the measurement of total dissolved gas by using measurements of oxygen in hydraulic fluid as a proxy for total dissolved gas in hydraulic fluid. It is assumed that the total dissolved gas is proportional to the total dissolved oxygen. A reading of total dissolved oxygen is obtained using an oxygen sensing device, and the result is and scaled to represent total dissolved gas as would be reported by contemporary gas chromatography analysis.

Another embodiment of the disclosed subject matter provides for the measurement of total dissolved gas by using measurements of oxygen in coolant oil as a proxy for total dissolved gas in coolant oil. Such a coolant oil measurement could be used in real-time for aerospace or industrial coolant systems to optimize process efficiency and alert users of system problems.

Another embodiment of the disclosed subject matter provides for the measurement of total dissolved gas by using measurements of oxygen in transformer oil as a proxy for total dissolved gas in transformer oil. Such a transformer oil measurement could be used in real-time for commercial and industrial transformers to optimize process efficiency and alert users of system failure.

Another embodiment of the disclosed subject matter uses an enclosed chamber of which at least a portion of the enclosing wall consists of a gas-permeable, liquid impermeable membrane. When the membrane is put in contact with the fluid, a pressure change occurs in the chamber, the equilibrium pressure being proportional to the amount of total dissolved gas in the fluid contacting the gas permeable membrane. A pressure measurement is made on the sealed chamber and related to total dissolved gas of the fluid.

Another embodiment of the disclosed subject matter consists of a fluidic component comprising a flow through chamber and a total dissolved gas sensor. The fluidic component is used to make a total dissolved gas measurement, in real time, on the fluid within a force- or volume-transfer fluidic system. The reading of the total dissolved gas sensor indicates when the fluid requires purification, or can be used to adjust operating parameters to minimize cavitation and other deleterious phenomena. Such a fluidic component and methods could be used on aircraft, in ships, in petroleum refining, and in other industrial fluidic systems to optimize in real time process efficiency and alert for system deficiencies.

Another embodiment of the disclosed subject matter provides for a feedback signal for use during purification of fluid. In this embodiment a TDG sensor makes a measurement on the fluid entering a purification system and reports purity based on TDG reading. When the reading of TDG is acceptably low, the purification process is stopped. The use of the TDG reading can be with an automated device that shuts off the process at a certain purity, or can be read by an operator to determine when to stop purification.

The advantages of the disclosed subject matter compared to the contemporary art are numerous. Contemporary art requires expensive instrumentation and dedicated operator personnel to measure TDG. It would be impractical to put the contemporary gas chromatographic measurements on-line in an aircraft hydraulic system, or in a fluid purification system. A TDG sensor used with a purification system will indicate when the optimum purification level, or extraction of TDG, has been reached, thereby reducing expense due to time and energy expenditures. When used in an industrial automation application, the TDG sensor will indicate the health of the fluidic system, and operating speed and pressures may be adjusted accordingly to maximize efficiency, effectiveness, and safety of a fluidic system. When the TDG sensor indicates that purity falls below a certain level, a system alarm can be triggered indicating the need for fluid purification.

### DRAWINGS

Attention is now directed to the drawing Figures, where like or corresponding numerals indicate like or corresponding components. In the drawings:

FIG. 1 is a schematic diagram of a fluidic component employing a TDG sensor.

FIGS. 2a-2c are schematic diagrams of one embodiment of a TDG sensor.

FIG. 3 is a schematic diagram of another embodiment of a TDG sensor in a fluidic component.

FIG. 4 is a diagram of an embodiment a membrane assembly employed by the TDG sensor shown in FIG. 4.

FIG. 5 is a schematic diagram of an apparatus employing a TDG sensor.

FIG. 6 is a diagram of measured TDG over time during a purification process.

### DETAILED DESCRIPTION

The subject matter disclosed herein is directed to apparatus and methods that use sensors to measure total dissolved gas (TDG) in force-transfer, or volume-transfer fluidic systems. One embodiment of a TDG sensor measures dissolved oxygen as a proxy to indicate TDG. Another embodiment of a TDG sensor measures the pressure of gas that diffuses across a membrane forming a portion of the wall of a sealed chamber in contact with the fluid. Apparatus and methods that employ the TDG sensors in fluidic components are disclosed. Apparatus and methods that use the output of TDG sensors to improve efficiency and operational cost of purification processes and systems, and performance and efficiency of force- or volume-transfer fluidic systems are disclosed. The disclosed subject matter will greatly improve the safety, efficiency and cost effectiveness of fluidic systems commonly in use in aircraft, ships, and a variety of industrial processes.

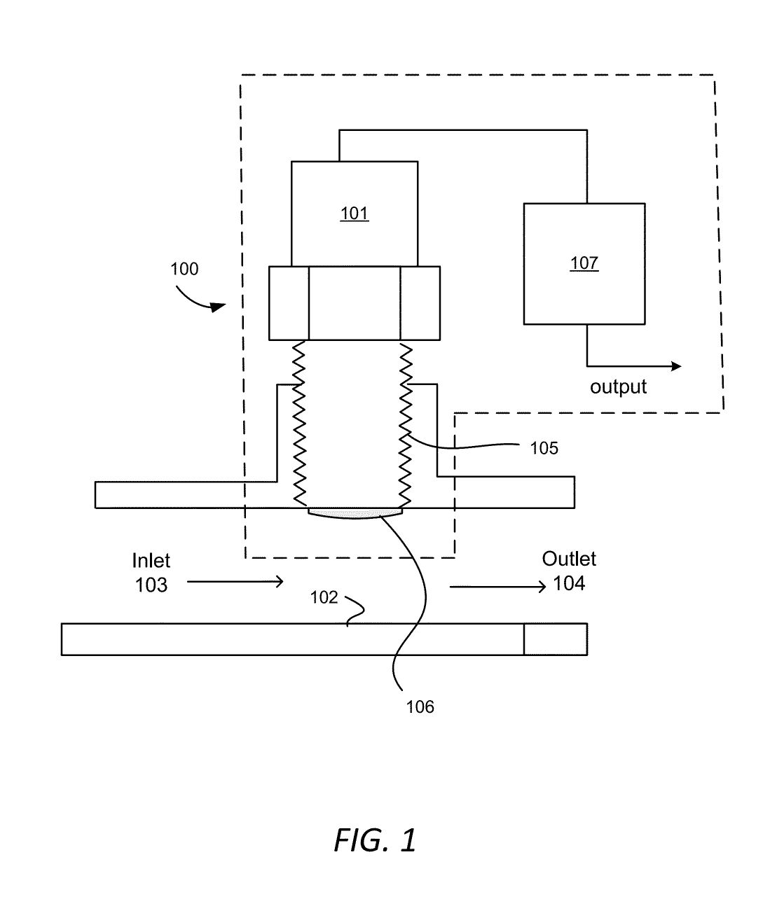

Attention is now directed to FIG. 1, that shows a cross sectional schematic view of the disclosed subject matter employed as a fluidic component for use in a force-transfer or volume-transfer fluidic system. The fluidic component 100 comprises a TDG sensor 101 and a fluidic conduit 102. The fluidic conduit further comprises an inlet 103, an outlet 104, and a sensor mount 105 or other means to hold the TDG sensor 101 in contact with the fluid.

The TDG sensor comprises 1) a transducer 106 that is in contact with fluid, and that performs a measurement of a physical, chemical or electrical natures that can be related to TDG concentration in the fluid, and 2) a control logic 107 that translates the output of the TDG transducer 106 into a signal representing TDG concentration. The signal output of the control logic 107 may be, for example, an analog voltage or current with a pre-defined relationship to TDG concentration. Alternatively the control logic 107 may output a binary signal that changes state when a certain level of TDG concentration is reached. The binary signal may be an electrical, visual or mechanical actuation to indicate level of TDG or that is used by an operator or another apparatus to perform some function, for example, starting or stopping a purifier, or changing the flow and pressure parameters of a fluidic system. The signal output of the control logic 107 may be a digital signal that is sent to another device for display of reading or for control of some fluidic parameter or for starting or stopping a purifier.

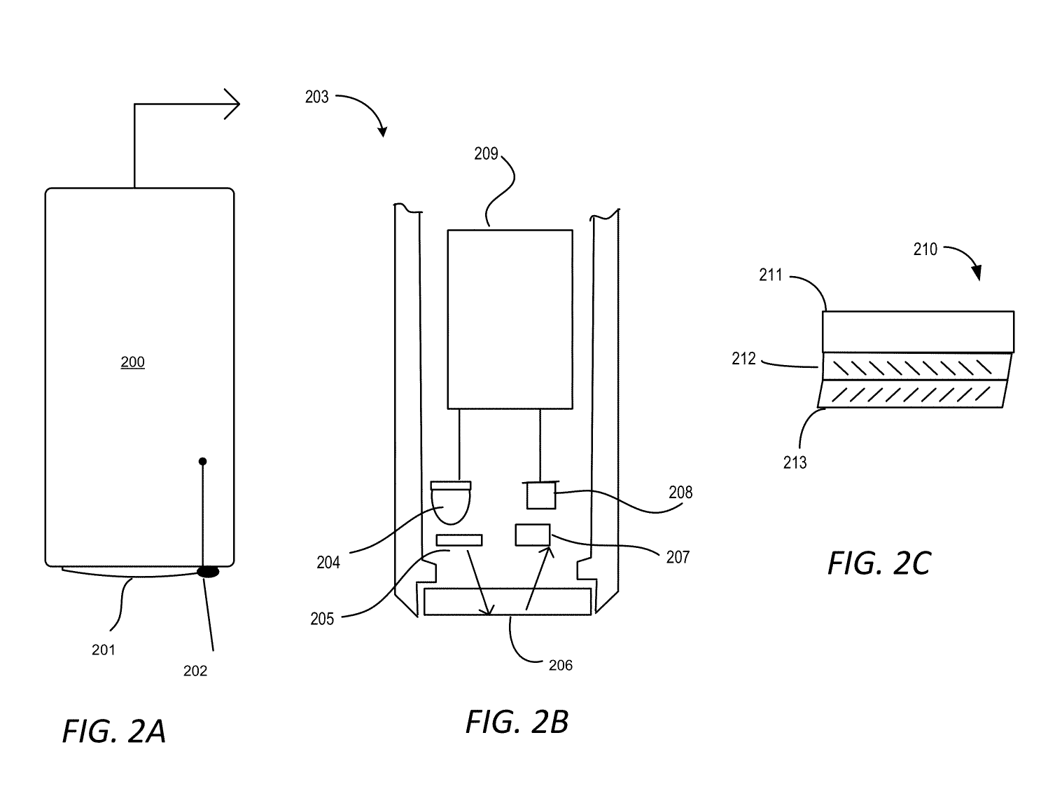

Attention is now directed to FIG. 2a, that shows the one embodiment 200 of a TDG sensor for fluidic systems. The TDG sensor 200 of FIG. 2a comprises a dissolved oxygen sensor 201 and a temperature sensor 202. The temperature sensor 202 may be integral with or separate from sensor 200. When sensor 200 is contacted with the fluid contained in the fluidic component of FIG. 1, it measures the amount of dissolved oxygen in the fluid. An assumption is made that the major components of dissolved gas in the fluid are oxygen and nitrogen, and that the ratio of dissolved oxygen and nitrogen is generally constant. This assumption is expressed below

[TDG]=[O₂]+[N₂] Eq. 1

The following example shows how TDG in hydraulic fluid can be measured using a dissolved oxygen sensor, though this example in no way limits the disclosed subject matter to the measurement TDG in hydraulic fluid. In a typical hydraulic fluid, for example Royco 782, the TDG concentration at equilibrium with the atmosphere (at standard temperature and pressure) is 12% by volume as measured by the gas chromatographic method. When the dissolved gasses are removed from hydraulic fluid and enter a gaseous state, the gasses occupy 12% of the volume of hydraulic fluid (when the evolved gasses are measured at standard temperature and pressure):

V_{TDG-STP}/V_{HF}=12% Eq. 2

where: V_{TDG} is the volume of evolved gas at STP.
V_{HF} is the volume of hydraulic fluid from which the gas evolved.

When converted to a mass ratio, accounting for the mass of V_{TDG} and V_{HF}, the concentration of TDG in hydraulic fluid is 160 parts per million (ppm).

Henry's law describes the proportionality of gas dissolved in a liquid with the partial pressure of that gas at the surface of the liquid, or for a system at equilibrium:

C=K*p Eq. 3

where: C=concentration of a gas in a liquid.
K=Henry's constant for solution of the gas in the liquid.
p=partial pressure of the gas at the surface of the liquid.
   Substituting Eq. 3 into Eq. 1 we find:

[TDG]=K_{O2}ppO₂+K_{N2}ppN₂ Eq. 4

where: K_{O2} and K_{N2} are the Henry's law constants for solution of oxygen and nitrogen respectively in hydraulic fluid.
ppO₂ and ppN₂ are the respective partial pressures of nitrogen and oxygen gas at the surface of the fluid that result in a dissolved gas concentration of [TDG].

It is assumed that when the hydraulic fluid is exposed to air outside of the fluidic system, that air consists of approximately 20% oxygen and 80% nitrogen and other gasses. Using this assumption with Eq. 4 yields:

[TDG]=K_{O2}ppO₂+5K_{N2}ppO₂ Eq. 5

Simplifying we find:

[TDG]=ppO₂(K_{O2}+5K_{N2}) Eq. 6

Therefore the measurement of the equivalent partial pressure of oxygen in hydraulic fluid, and the knowledge of Henry's law constants for oxygen and nitrogen are known empirically or theoretically, is sufficient to give [MG]. In practice the quantity K_{O2}+5K_{N2} is determined empirically by measuring the equivalent ppO₂ in a sample of hydraulic fluid of known [TDG]. Equivalent ppO₂ is defined as the partial pressure of oxygen at the surface of the fluid that is required to create the oxygen concentration [O₂] of Eq. 1 that is dissolved in the fluid. Equivalent ppO₂ can be measured using a dissolved oxygen sensor as discussed below that does not measure the actual concentration of oxygen in the fluid, but a value that is proportional to dissolved oxygen concentration and to ppO₂.

It is not a requirement that the Henry's law constants of O₂ and N₂ be equal, that is the concentration of these gasses in the fluid do not need to be in the atmospheric ratio of 1 to 5, but the only requirement is the proportionality remains constant, and that neither the oxygen nor nitrogen in the fluid is not consumed over time by a chemical reaction or other process.

A membrane covered electrochemical oxygen sensor, or a quenched luminescent oxygen sensor may function as the sensor 200 that is used to measure the ppO₂ of Eq. 6. A quenched luminescent oxygen sensor has the advantage that it does not consume oxygen and it does not show measurement dependence on rate of fluid flow across the surface of the sensor.

Attention is now directed to FIG. 2b, that shows the one embodiment of an oxygen sensor 203 for TDG measurement that uses quenched luminescent sensing principles. The sensor comprises an excitation LED 204, excitation filter 205, sensor element 206, detection filter 207, detector 208 and measurement logic 209. The measurement logic 209 causes the LED 204 to generate excitation light energy that is directed through excitation filter 205 (to remove longer wavelengths of light) onto sensor element 206. The sensor element 206 absorbs the excitation light energy and emits luminescence light energy which passes through detection filter 207 and reaches detector 208. Some property of the luminescence light energy, for example the amplitude, lifetime or phase shift, are determined by measurement logic 209 which then derives an answer equivalent to oxygen partial pressure. The exact configuration of the quenched luminescence oxygen sensor 203 is not critical and one skilled in the art will be able to conceive of various suitable configurations.

It is important to note that the quenched luminescence oxygen sensor 203 indirectly measures the partial pressure, ppO₂ of Equation 6. The actual quantity measured is a quantity that is related to the ppO₂ that would exist at the surface of a sample of hydraulic fluid to create the present concentration of oxygen, and total dissolved gas according to Eq. 6. The quenched luminescence sensor 203 measures the concentration of oxygen in the sensor element, which has its own Henry's law constant. The composite of various Henry law constant's and proportionality constants are inherently determined by a calibration relating the output quantity of the quenched luminescent oxygen sensor 203 to samples containing known [TDG].

A sensor element 210 is shown in FIG. 2c and comprises a substrate 211, an active sensing layer 212, and an optical buffer layer 213. The substrate 211 must have the properties of oxygen impermeability and optical transmission of the excitation light energy and emission luminescence energy. One suitable material for the impermeable substrate 211 is quartz or glass. The active sensing layer 212 comprises an oxygen permeable layer into which an oxygen sensitive luminescent dye is dispersed. Suitable material for the oxygen permeable layer include polymers that has sufficiently high oxygen permeability, and that are resistant to the effects hydraulic fluid, such as polydimethly siloxanes and derivatives, and fluorine containing carbon-based polymers. Numerous examples of oxygen sensitive luminescent dyes are useful, and include the class of molecules selected from metallo-porphyrin and organo Ruthenium dyes. The optical buffer layer 213 should prevent excitation light energy from reaching the hydraulic fluid. This is required because the fluid being analyzed for TDG often is fluorescent, and the fluorescence would interfere with the oxygen measurement. One suitable material for optical buffer layer 213 include polydimethyl siloxane with a red or black pigment dispersed in the layer.

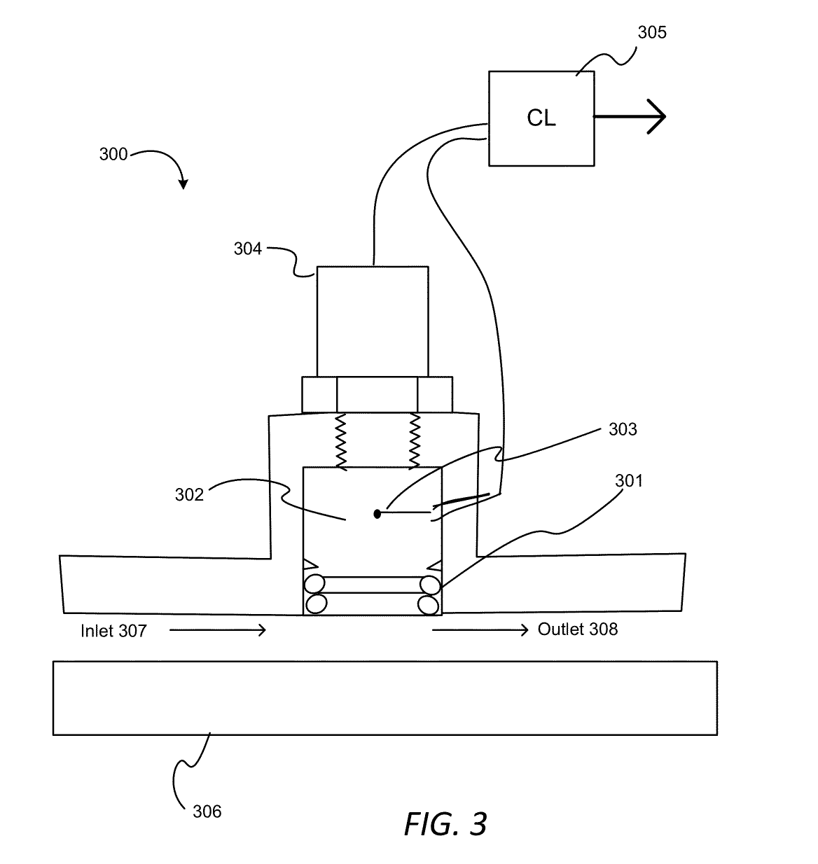

Attention is now directed to FIG. 3, that shows a schematic cross-section of another embodiment 300 of a TDG sensor of the fluidic component apparatus shown in FIG. 1. The TDG sensor 300 of FIG. 3 comprises a gas permeable membrane assembly 301, a gas chamber 302, a temperature sensor 303, a pressure sensor 304 and control logic 305. The TDG sensor 300 of FIG. 3 is integral with a fluidic component, though one skilled in the art could easily design a configuration in which all parts of the TDG sensor 300, the membrane assembly 302, gas chamber 303, and pressure sensor 304 were part of a single unit that connects to the fluidic component. When fluid fills the fluidic component 306 holding the TDG sensor through inlet 307, fluid contacts the gas permeable membrane 301. Depending on the concentration of dissolved gas in the fluid, gas will diffuse across the membrane 301, either from the fluid to the chamber 302, or from the chamber 302 to the fluid, until an equilibrium condition is met. The diffusion of gas to or from the chamber 302 results in a either a pressure change, volume change or both, depending if the chamber 302 is designed to be a fixed or variable volume and pressure. FIG. 3 discloses the use of a fixed volume chamber 302, the pressure of which varies depending on the amount and direction of gas diffusion across the membrane. Alternate embodiments could use a variable volume chamber.

Once equilibrium is achieved, the pressure within the chamber 302 is measured by the pressure sensor 304 and related to the concentration of dissolved gas in the hydraulic fluid according to Henry's law, Eq. 3. For example if hydraulic fluid passing through the system of FIG. 3 from inlet 307 to outlet 308 was in equilibrium with air at standard temperature and pressure, the concentration of TDG would be 12% or 160 ppm. If the gas contained in the chamber 302 were at a lower pressure than standard pressure, gas would diffuse across the membrane 301 into the chamber 302 until the standard pressure was reached in order to maintain the equilibrium predicted by Henry's law. If for example, new hydraulic fluid containing 6%, or 80 ppm TDG were introduced into the chamber 302, the gas in the chamber 302 would diffuse through the membrane 301 into the hydraulic fluid until ½ the standard pressure was reached in the chamber 302 since this corresponds to the equilibrium pressure predicted by Henry's law.

In practice the equilibrium pressure condition may not always be reached for several reasons. Attaining the equilibrium condition requires a finite amount of time, and an effective infinite volume of hydraulic fluid. If the [TDG] of the hydraulic fluid in the fluidic component 306 of FIG. 3 is not constant, the pressure in the chamber 302 will not represent the equilibrium value. If the flow rate of fluid across the gas permeable membrane 301 is not sufficiently high, a concentration gradient may develop at the surface of the membrane 301 and result in an equilibrium pressure value that does not represent the bulk of the fluid. If the membrane 301 flexes and causes the volume of chamber 302 to change the pressure will contain systematic error. If the membrane 301 is clogged with particles or a surface film the decreased gas diffusion rate would increase response time and cause further systematic errors. If the chamber 302 is not at standard temperature, the pressure reading will inaccurately reflect the equilibrium value.

Several methods can be used to address these potential inaccuracies. The temperature of the chamber 302 should be measured, and the measured pressure corrected to pressure at standard temperature. A support structure should be used to prevent the membrane from deforming and changing chamber volume. A membrane composition that discourages fouling or film formation should be used. For example the class of fluorine containing polymers generally known under the trade names Teflon, PFA, Tefzel, Teflon AF, Kynar, are suitable materials. The response time of the TDG sensor 300 may also be checked periodically to determine when the gas permeable membrane 301 has excessively fouled. The reading of the TDG sensor 300 should also be periodically checked against a sample of fluid with known TDG. The flow rate through the fluidic component 306 could be used to calculate the anticipated response time.

The control logic 305 acquires a reading from the pressure sensor 304, and the temperature sensor 303, applies corrections and calibrations as needed to determine [TDG]. In the pressure-based TDG sensor 300 described in FIG. 3, the [TDG] is generally related to measured pressure as follows:

[TDG]=kP*P_{chamb} Eq. 7

where: k is a proportionality constant determined empirically or theoretically.
P_{chamb} is the measured pressure in the chamber.

The ideal gas law can be used to correct for the pressure in the chamber 302 using the relationship:

P_{Ts}=P_{chamb} T_{S}/T_{chamb} Eq. 8

where: P_{Ts} is the pressure of the chamber corrected to standard temperature T_{S}.
P_{chamb} is the pressure measured in the chamber.
Tₛ is the standard temperature, e.g. 298° K.
T_{chamb} is the measured chamber temperature.

In practice it is anticipated that an empirical calibration of sensor 300 response over temperature and pressure will be made since many of the proportionality constants, including Henry's law constants and k of Eq. 7 are temperature dependent.

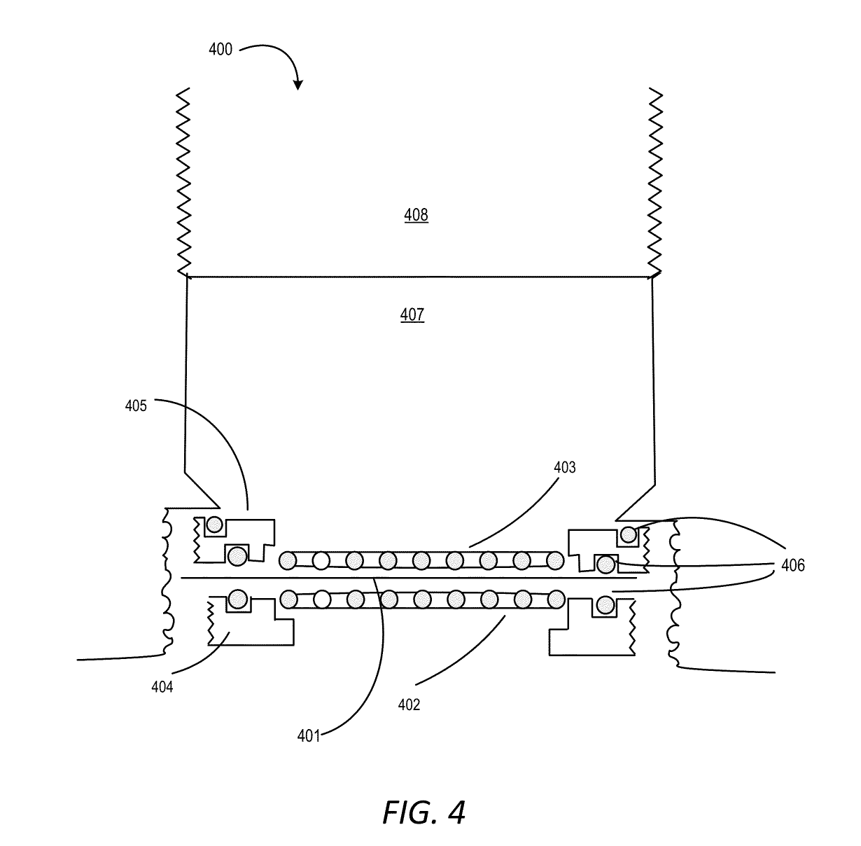

The membrane assembly 400 of FIG. 4 comprises a gas permeable, fluid impermeable membrane 401, a means 406 for achieving a fluid and airtight seal, and support structure. The membrane assembly 400 comprises a gas permeable membrane 401, a lower support structure 402, an upper support structure 403, a lower support retainer 404, an upper support retainer 405 and a chamber seal 406. The upper support structure 403 and lower support structure 402, for example a heavy wire mesh or grid, are held against the membrane 401 with an upper support retainer 405 and a lower support retainer 404. The lower support retainer 404 and upper support retainer 405 have seals 406, such as O-rings, that makes a gas tight seal against the opening of the chamber 407. The pressure transducer 408 also forms an air tight seal against with the chamber 407.

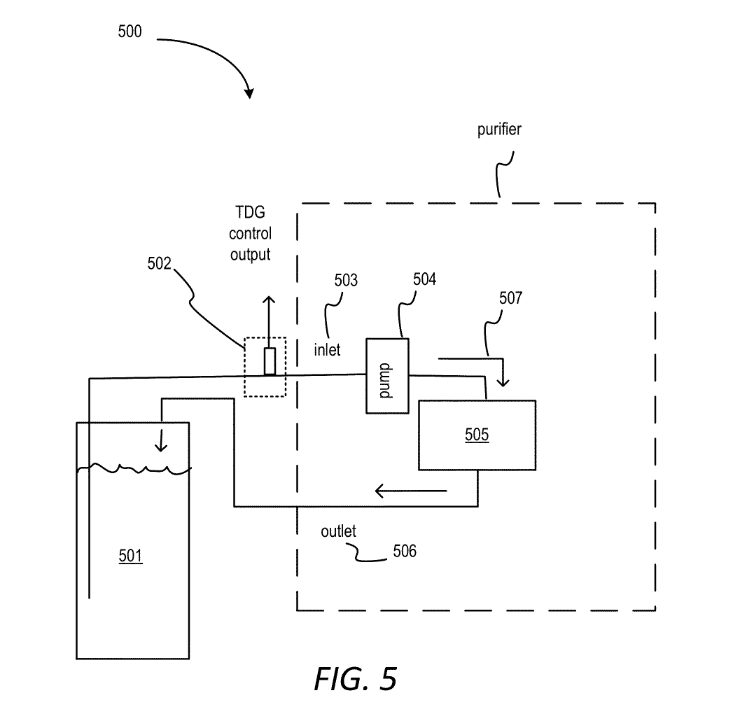

Attention is now directed to FIG. 5, that shows the one embodiment of a fluid purification apparatus 500 using the oxygen sensor of FIG. 2 for TDG measurement. The fluid purification apparatus 500 comprises a reservoir 501, a TDG sensor 502, an inlet 503, a pump 504, a purification chamber 505, and an outlet 506. The pump 504 causes the fluid to travel from the reservoir 501 to the inlet of the purifier 503. Before entering the inlet 503, the fluid passes through a fluidic component 502 containing a TDG sensor. The fluid travels into the purifier 500 with the pump 504 providing a means of volume transfer for the entire system 500. The fluid enters a purification chamber 505 where is subject to a low pressure that causes dissolved gasses to evolve. The fluid then travels to the outlet 506 where it is returned to the reservoir 501.

In example of use of the disclosed apparatus, the TDG sensor of FIG. 2 was used in the fluid purification apparatus of FIG. 5. The reservoir consisted of a 55 gallon drum of Royco 782 hydraulic fluid, and the purifier consisted of a commercially available portable fluid purifier manufactured by the Pall Corporation, East Hills, N.Y., USA. Prior to initiating the purification of the fluid in the reservoir, compressed air was bubbled through the reservoir to ensure that the hydraulic fluid was saturated with air. The purifier was started and hydraulic fluid from the reservoir flowed past the TDG sensor, through the purifier and returned to the reservoir.

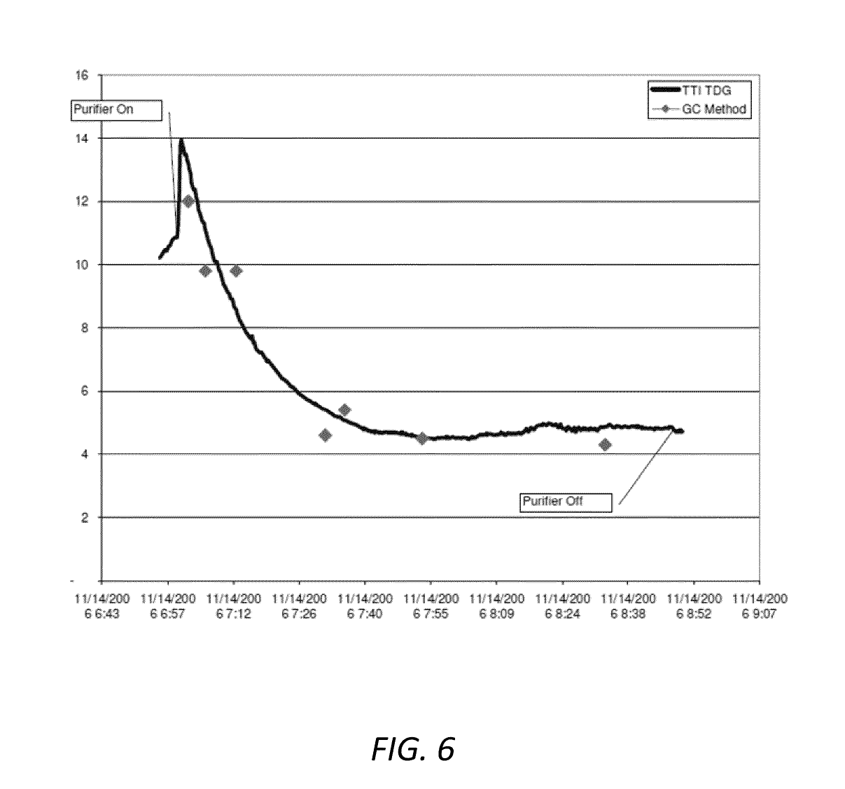

FIG. 6 shows the output of the control logic of the TDG sensor shown in FIG. 2 that was used with purification apparatus of FIG. 5. Initially the TDG sensor read a value of about 10% which was the TDG level of residual hydraulic fluid in the purifier inlet line. When the purifier was started, hydraulic fluid from reservoir entered the inlet line and the TDG sensor showed a value of 14% TDG. The value of TDG reported by the sensor immediately started to fall as the purification progressed, eventually leveling off at about 5%. During the test samples of hydraulic fluid were periodically taken from the inlet stream and measured using the gas chromatographic method. Results of the GC measurements are shown as discrete points. Excellent correlation between the readings of the disclosed apparatus and the accepted standard GC method were achieved. Moreover the disclosed apparatus acquired data at intervals of 15 seconds automatically and without requiring any user intervention. After some time it was determined from the reading of the TDG sensor that the purification process had removed a sufficient amount of TDG and the purifier was stopped by an operator.

A small discrepancy exists between the first GC measurement, TDG=12%, and the maximum TDG reading from the disclosed apparatus, TDG=14%. The GC sample was taken from the top of the fluid reservoir immediately before purification began. The TDG sensor is in the inlet which receives its hydraulic fluid from the lower portion of the reservoir. It is believed that the saturation of air in the bottom of the reservoir is greater than at the top for the following reason; prior to purification compressed air was introduced into the reservoir using an air hose that was placed at the bottom of the reservoir. The air bubbles exiting the air hose at the bottom of the reservoir are at a higher pressure than the air bubbles at the top due to the static pressure of the fluid. Therefore a non-uniform, increasing TDG concentration with depth is expected. The GC sample was taken from the top of the reservoir, while the inlet fluid passing the TDG sensor was taken from the higher TDG concentration bottom portion of the barrel.

Alternative embodiments would use the control logic of the apparatus disclosed in FIG. 1 to provide a feedback to the parameters of a force- or volume-transfer system. By way of example a purification process could be stopped when a certain level of TDG concentration is reached, or when the TDG level has fallen to a certain fraction of the level that was measured before purification began. Another example of use of the disclosed subject matter would be to use the reading of the disclosed apparatus to change automatically or with user intervention, the flow rate and/or pressure of a volume-transfer or force transfer fluidic system in order to prevent cavitation or other undesired phenomena.

While preferred embodiments of the disclosed subject matter have been described, so as to enable one of skill in the art to practice the disclosed subject matter, the preceding description is intended to be exemplary only. It should not be used to limit the scope of the disclosure, which should be determined by reference to the following claims.

We claim:

1. A fluidic component for measurement of total dissolved gas in a fluid in a fluidic system.

2. The component of claim 1 comprising an inlet, a fluid outlet, a conduit and a TDG sensor in contact with the fluid in the conduit.

3. The component of claim 2 where the TDG sensor is a dissolved oxygen sensor.

4. The component of claim 3 where the dissolved oxygen sensor comprises a luminescent oxygen sensor.

5. The component of claim 3 where the dissolved oxygen sensor comprises an electrochemical oxygen sensor.
